(19) United States
(12) Patent Application Publication
(10) Pub. No.: US 2020/0189611 A1
(43) Pub. Date: Jun. 18, 2020

(54) AUTONOMOUS DRIVING USING AN ADJUSTABLE AUTONOMOUS DRIVING PATTERN

(71) Applicant: CARTICA AI LTD, Tel Aviv (IL)

(72) Inventors: Igal Raichelgauz, Tel Aviv (IL); Karina Odinaev, Tel Aviv (IL)

(21) Appl. No.: 16/708,441

(22) Filed: Dec. 10, 2019

Related U.S. Application Data
(60) Provisional application No. 62/778,333, filed on Dec. 12, 2018.

(51) Int. Cl. B60W 50/08; G08G 1/01; G05D 1/00; B60W 30/18; G05D 1/02

(52) U.S. Cl. CPC B60W 50/08; G08G 1/0133; G05D 1/0088; B60W 2050/0095; G05D 1/0214; G05D 2201/0213; B60W 30/18

(57) ABSTRACT

There may be provided a method for autonomous driving, the method may include: receiving, from a vehicle, and by an I/O module of a computerized system, (a) driving information indicative of a manner in which a driver controls the vehicle while driving over a path, and (b) environmental sensor information indicative of information sensed by the vehicle, the environmental sensor information is indicative of the path and the vicinity of the path; detecting, based on at least the environmental information, multiple events encountered during the driving over the path; determining event types, wherein each of the multiple events belongs to a certain event type; for each event type, determining, based on driving information associated with events of the multiple events that belong to the event type, a tailored autonomous driving pattern information that is indicative of a tailored autonomous driving pattern to be applied by the vehicle during an occurrence of the event type; for each event type, determining, based on environmental sensor information associated with events of the multiple events that belong to the event type, an event type identifier; and storing in at least one data structure (a) event type identifier for each one of the multiple types of events, and (b) tailored autonomous driving pattern information for each one of the multiple types of events.

### CROSS REFERENCE

This application claims priority from U.S. provisional patent Ser. No. 62/778,333 filing date Dec. 12, 2018.

### TECHNICAL FIELD

The present disclosure generally relates to detecting and avoiding obstacles in an autonomous driving environment.

### BACKGROUND

An autonomous driving system is expected to control, in the near future, an autonomous vehicle in an autonomous manner.

A driving pattern applied by the autonomous driving system may cause a certain human within the vehicle to be uncomfortable, while another human may view the same driving pattern as pleasurable.

This may cause various users not to purchase an autonomous vehicle and/or may cause automatic driving system vendors to develop sub-optimal driving patterns.

There is a growing need to provide a method, system and non-transitory computer readable medium for providing better driving patterns.

### BRIEF DESCRIPTION OF THE DRAWINGS

The embodiments of the disclosure will be understood and appreciated more fully from the following detailed description, taken in conjunction with the drawings in which:

FIGS. 1-3 illustrate examples of methods;

FIG. 4 is a partly-pictorial, partly-block diagram illustration of an exemplary obstacle detection and mapping system, constructed and operative in accordance with embodiments described herein;

FIG. 5 is a block diagram of an exemplary autonomous driving system to be integrated in the vehicle of FIG. 4;

FIG. 6 is a flowchart of an exemplary process to be performed by the autonomous driving system of FIG. 5;

FIG. 7 is a block diagram of an exemplary server of FIG. 4; and

FIG. 8-18 illustrate various examples of scenarios.

### DESCRIPTION OF EXAMPLE EMBODIMENTS

There may be provided a system, method and computer readable medium for adapting one or more autonomous driving patterns to one or more human driving patterns of a user associated with the vehicle.

The one or more human driving patterns may be learnt during one or more learning periods.

The learning process may be based on information sensed by the vehicle, and does impose a minimal load on the resources of the vehicle.

The adapting the one or more autonomous driving pattern to the one or more human driving patterns of a user, greatly simplifies the development process of the autonomous driving system, and may allow using more simple autonomous driving decision making and policy system—thus reducing computational and storage resources that were otherwise allocated to the executing and storing of the autonomous driving patterns.

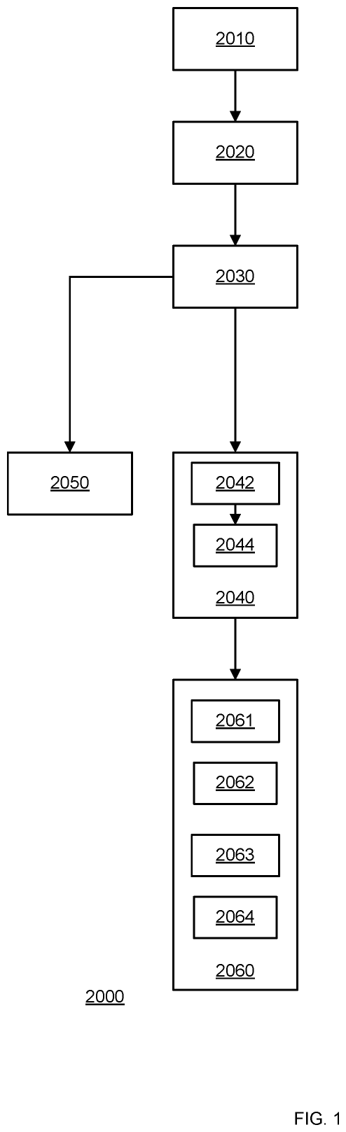

FIG. 1 illustrates method 2000 for autonomous driving.

Method 2000 may start by step 2010 of receiving, from a vehicle, and by an I/O module of a computerized system, (a) driving information indicative of a manner in which a driver controls the vehicle while driving over a path, and (b) environmental sensor information indicative of information sensed by the vehicle, the environmental sensor information is indicative of the path and the vicinity of the path.

The driving information may be obtained from sensors such as visual and/or non-visual sensors. For example—the manner in which the driver controls the vehicle may be learnt from at least one out of a driving well sensor, brakes sensor, gear sensors, engine sensors, shock absorber sensors, accelerometers, and the like. Additionally or alternatively the manner in which the driver control the vehicle can be learnt from images acquired by a sensor such as a LIDAR, radar, camera, sonar that may be used to evaluate the direction, velocity, acceleration, of the vehicle.

The driving information and/or the environmental sensor information may include raw sensor data or processed sensor data.

Step 2010 may be followed by step 2020 of detecting, based on at least the environmental information, multiple events encountered during the driving over the path.

Step 2020 may be performed in a supervised manner, in an unsupervised manner, based on object recognition, and the like.

Step 2020 may include segmenting the environmental sensor information to segments (for example segmenting a video stream to segments of video and even to single frames), and processing the segments to detect events.

The segments may be of the same length, of the same size, may differ from each other by length, may differ from each other by size, may be segments in a random manner, may be segmented in a pseudo-random manner, may be segmented based on the driving information (for example—shorter segments when the vehicle changes its velocity, when the acceleration of the vehicle rapidly changes, and the like.

Step 2020 may include finding events and determining the parameters of the event. This may include searching for predefined (or dynamically learnt) parameters.

Events and/or event types may exhibit one or more parameters such as:
Location.
Type of path and/or type of environment (highway, urban area, roundabout, road crossing, junction).
One or more object that appear in the environmental sensor information (pedestrian, car, building, or lower level of granularity of objects: ambulance, truck, motorcycle, bike, pedestrian with stroller, pedestrian talking on the phone, scooter rider, and the like).
Behavior of the one or more objects (pedestrian that is about to cross the road, vehicle ahead speeding, vehicle ahead slowing down, vehicle bypassing).
Spatial and temporal relationship between the vehicle and any of the objects.

An event and/or an event type may be characterized by any number of parameters—thus some events may be more general than others.

Step 2020 may be followed by step 2030 of determining event types, wherein each of the multiple events belongs to a certain event type.

The determining of the event types may include clustering the events, classifying the events or performing any other method for determining the event types.

The determining of the event types may be performed based on one or more parameters of the event.

The determining of the event types and/or the determining of the events may also be based on the driving information. For example—a abrupt change in a driving parameter may indicate that there is an event. Yet for another example—substantially different driving patterns applied at substantially the same event may be used to split an event type to different event types.

Step 2030 may be followed by step 2040 of determining, for each event type, and based on driving information associated with events of the multiple events that belong to the event type, tailored autonomous driving pattern information that is indicative of an autonomous driving pattern to be applied by the vehicle during an occurrence of the event type.

The autonomous driving pattern information is tailored in the sense that is determined, at least in part, based on a human driving patterns of a certain driver (user) or of a certain vehicle. The tailoring may involve adapting an autonomous driving pattern, generating a new autonomous driving pattern, changing one or more aspects of the autonomous driving pattern, and the like. The aspects may include any speed, acceleration, gear changes, direction, pattern of progress, and any other aspect that is related to the driving of the vehicle and/or to an operation of any of the units/components of the vehicle.

Step 2040 may include step 2042 of determining, for each event type, a representative human driving pattern applied by the driver, based on driving information associated with events of the multiple events that belong to the event type. Different events of the same event type may be linked to multiple human driving patterns—some of which may differ from each other. The representative human driving pattern may be calculated by applying any function on the multiple human driving patterns—for example averaging, weighted averaging, ignoring extremum driving patterns, and the like.

Examples for human driving patterns associated with different event types include:
Given a yellow light, the driver slows down and stops, even before the red light.
The driver only starts bypassing another vehicle if the driver ahead drives slower than a certain velocity.
In the traffic, the driver starts driving only when having a certain number of meters space from the car in the front.
In the highway the driver usually has a certain number of meters space before the car ahead.
The driver usually accelerates at a certain rate when green light arrives.
Before zebra crossing the driver usually slows down even if no pedestrians are visible.
The driver usually sticks to the right lane even if multiple lanes available.
The driver usually signals a certain number of minutes before the turn.
The driver user usually fuels the car at certain gas stations and/or when a certain amount of gas remains in the vehicle.
The driver tends to bypass obstacles that are more than few centimeters deep.
The driver lowers the vehicle average speed by a certain amount at certain times (sunset, night) and/or at certain conditions (fog, visibility problems).
The driver tends to enter a roundabout at a certain velocity when the roundabout is clear.

Step 2042 may be followed by step 2044 of determining autonomous driving pattern to be applied by the vehicle during an occurrence of the event type, based on (at least) the representative human driving pattern.

Step 2040 may be responsive to at least one other autonomous driving rule related to a driving of the vehicle during an autonomous driving mode.

The at least one other autonomous driving rule may be a safety rule. For example—the safety rule may limit a speed of the vehicle, may limit an acceleration of the vehicle, may increase a required distance between vehicles, and the like.

The at least one other autonomous driving rule may be a power consumption rule. The power consumption rule may limit some maneuvers that may involve a higher than desired power consumption of the vehicle.

The at least one other autonomous driving rule may be a default driving pattern that should have been applied by the autonomous driving system at the absence of method 2000.

The at least one other autonomous driving rule may be a human intervention policy of a vehicle that may define certain criteria human intervention such as the danger level of a situation, the complexity of the situation (especially complexity of maneuvers required to overcome the situation), the potential damage that may result to the vehicle, driver or surroundings due to the situation. A human intervention policy of a vehicle may also define certain situations that require human intervention—such as specific locations (for example near a cross road of a school), or specific content (near a school bus), and the like.

Step 2040 may also be responsive to input provided by the user—for example the user may determine the amount of adaptation of the driving pattern to the human driving patterns of the user.

Step 2040 may involve applying any function on the representative human driving pattern and on a default autonomous driving pattern to provide the autonomous driving pattern to be applied by the vehicle during an occurrence of the event type.

The event type autonomous driving pattern information may include instructions to the autonomous driving system, may include parameters of the autonomous driving pattern, may include retrieval information for retrieving the autonomous driving pattern, and the like.

Step 2030 may be followed by step 2050 of determining, for each event type, based on environmental sensor information associated with events of the multiple events that belong to the event type, an event type identifier.

The event type identifier should assist in identifying the event before the event starts—in order to allow the autonomous driving system to apply the required autonomous driving pattern.

Steps 2040 and 2050 may be followed by step 2060 of responding to the outcome of steps 2040 and 2050.

For example—step 2060 may include at least one out of:
Storing in at least one data structure (a) event type identifier for each one of the multiple types of events, and (b) tailored autonomous driving pattern information for each one of the multiple types of events. Step 2061.
Transmitting to the vehicle the event type identifier for each one of the multiple types of events, and the tailored autonomous driving pattern information for each one of the multiple types of events. Step 2062.
Instructing the vehicle to apply, for each event type, a driving pattern indicated by the tailored autonomous driving pattern information of the event type. Step 2063.
Requesting the vehicle to apply, for each event type, a tailored autonomous driving pattern of the event type. Step 2064.

The aggregate size of the driving information and the environmental sensor information exceeds as aggregate size of the (a) event type identifier for each one of the multiple types of events, and (b) the tailored driving information for each one of the multiple types of events. Accordingly—the method reduces the amount of memory resources that should allocated for storing the relevant information.

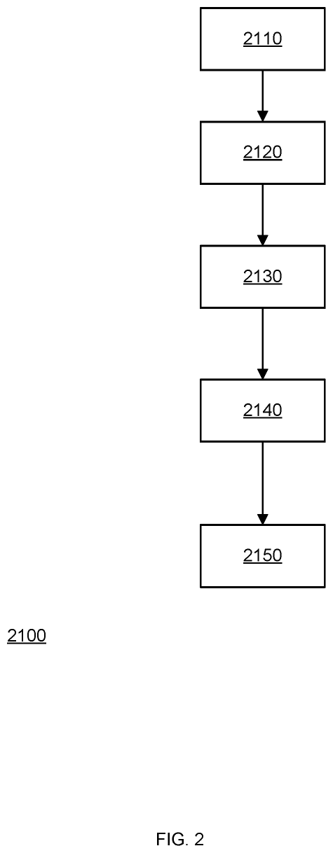

FIG. 2 illustrates method 2100 for driving a vehicle.

Method 2100 may start by step 2110 of receiving, by the vehicle, multiple event type identifiers related to multiple types of events that occurred during a driving of the vehicle over a path, and (b) tailored autonomous driving pattern information for each one of the multiple types of events.

A tailored autonomous driving pattern information of an event type is indicative of a tailored autonomous driving pattern associated to the event type.

Step 2110 may be followed by step 2120 of sensing, by the vehicle and while driving on a current path, currently sensed information that is indicative of a vicinity of the vehicle and information about a current path.

Step 2120 may be followed by step 2130 of searching, based on the currently sensed information, for an event type identifier out of the multiple event type identifiers.

When detecting an event type then step 2130 is followed by step 2140 of applying the tailored autonomous driving pattern of the event type.

Once the event type ends (this should be detected by the vehicle) the autonomous driving system may apply another autonomous driving pattern.

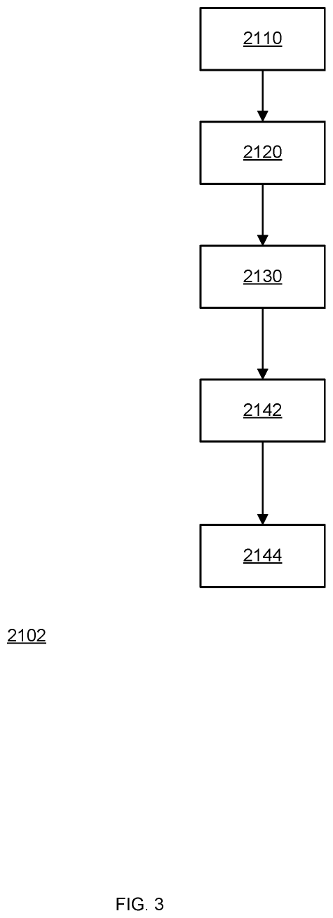

FIG. 3 illustrates method 2102 for driving a vehicle.

Method 2102 may start by step 2110 of receiving, by the vehicle, multiple event type identifiers related to multiple types of events that occurred during a driving of the vehicle over a path, and (b) tailored autonomous driving pattern information for each one of the multiple types of events.

Step 2110 may be followed by step 2120 of sensing, by the vehicle and while driving on a current path, currently sensed information that is indicative of a vicinity of the vehicle and information about a current path.

Step 2120 may be followed by step 2130 of searching, based on the currently sensed information, for an event type identifier out of the multiple event type identifiers.

When detecting an event type then step 2130 is followed by step 2142 of determining whether to apply a tailored autonomous driving pattern of the event type.

Step 2142 may be followed by step 2144 of selectively applying, based on the determining, the tailored autonomous driving pattern of the event type.

Step 2144 may include:
If determining not to apply the tailored autonomous driving pattern of the event type than another autonomous driving pattern (for example a default one) may be applied.
If determining not to apply the tailored autonomous driving pattern of the event type the applying the autonomous driving pattern related to the event type.

Step 2142 may be responsive to at least one other autonomous driving rule related to a driving of the vehicle during an autonomous driving mode.

The at least one other autonomous driving rule may be a safety rule. For example—the safety rule may limit a speed of the vehicle, may limit an acceleration of the vehicle, may increase a required distance between vehicles, and the like.

The at least one other autonomous driving rule may be a power consumption rule. The power consumption rule may limit some maneuvers that may involve a higher than desired power consumption of the vehicle.

The at least one other autonomous driving rule may be a default driving pattern that should have been applied by the autonomous driving system at the absence of method 2102.

Step 2142 may also be responsive to input provided by the user—for example the user may determine whether (and how) to apply the autonomous driving pattern related to the event type.

Step 2142 may also be based on environmental conditions—for example—change in the visibility and/or humidity and/or rain or snow may affect the decision.

It should be noted that there may be more than one driver of the vehicle and that different autonomous driving pattern related to the the event type may be learnt (per driver) and applied.

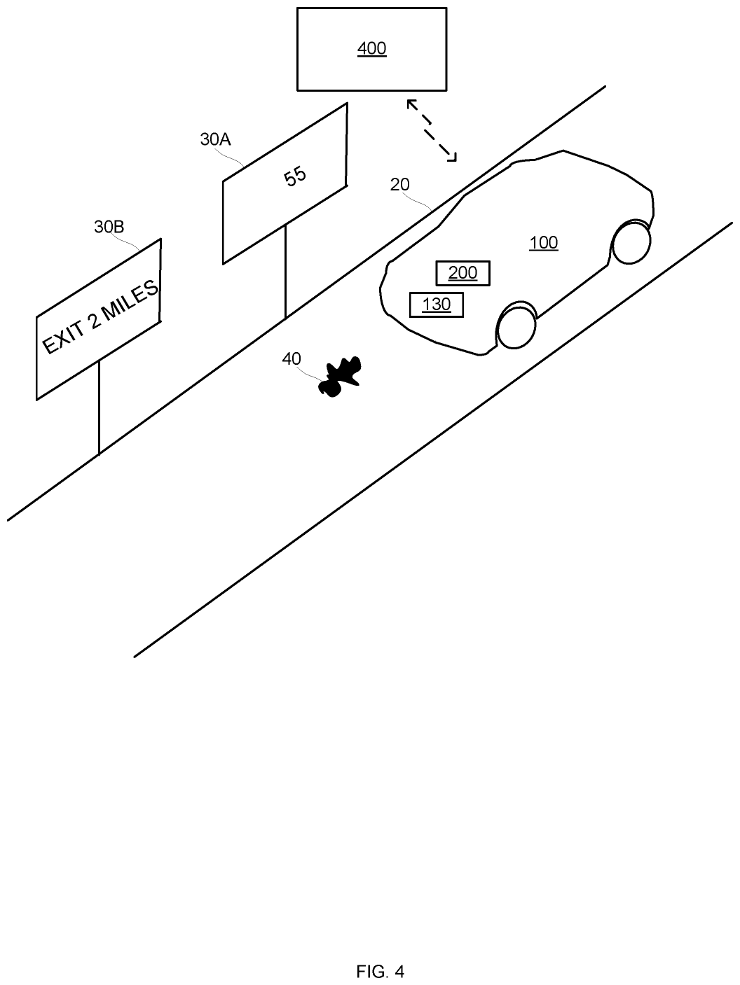

Reference is now made to FIG. 4, which is a partly-pictorial, partly-block diagram illustration of an exemplary system 10 constructed and operative in accordance with embodiments described herein.

System 10 comprises vehicle 100 and a remote computerized system such as remote server 400 which may be configured to communicate with each other over a communications network such as, for example, the Internet.

In accordance with the exemplary embodiment of FIG. 4, vehicle 100 may be configured with an autonomous driving system 200 operative to autonomously provide driving instructions to vehicle 100 without the intervention of a human driver. It will be appreciated that the embodiments described herein may also support the configuration of vehicle 100 with an assisted (or “semi-autonomous”) driving system where in at least some situations a human driver may take control of vehicle 100 and/or where in at least some situations the semi-autonomous driving system provides warnings to the driver without necessarily directly controlling vehicle 100.

Remote system 400 may executed method 2000. Vehicle 10 may execute method 2100 and/or method 2102.

In accordance with the exemplary embodiment of FIG. 4, vehicle 100 may be configured with at least one sensor 130 to provide information about a current driving environment as vehicle 100 proceeds along roadway 20. It will be appreciated that while sensor 130 is depicted in FIG. 4 as a single entity, in practice, as will be described hereinbelow, there may be multiple sensors 130 arrayed on, or inside of, vehicle 130. In accordance with embodiments described herein, sensor(s) 130 may be implemented using a conventional camera operative to capture images of roadway 20 and objects in its immediate vicinity. It will be appreciated that sensor 130 may be implemented using any suitable imaging technology instead of, or in addition to, a conventional camera. For example, sensor 130 may also be operative to use infrared, radar imagery, ultrasound, electro-optics, radiography, LIDAR (light detection and ranging), etc. Furthermore, in accordance with some embodiments, one or more sensors 130 may also be installed independently along roadway 20, where information from such sensors 130 may be provided to vehicle 100 and/or server 400 as a service.

In accordance with the exemplary embodiment of FIG. 4, static reference points 30A and 30B (collectively referred to hereinafter as static reference points 30) may be located along roadway 20. For example, static reference point 30A is depicted as a speed limit sign, and static reference point 30B is depicted as an exit sign. In operation, sensor 130 may capture images of static reference points 30. The images may then be processed by the autonomous driving system in vehicle 100 to provide information about the current driving environment for vehicle 100, e.g., the speed limit or the location of an upcoming exit.

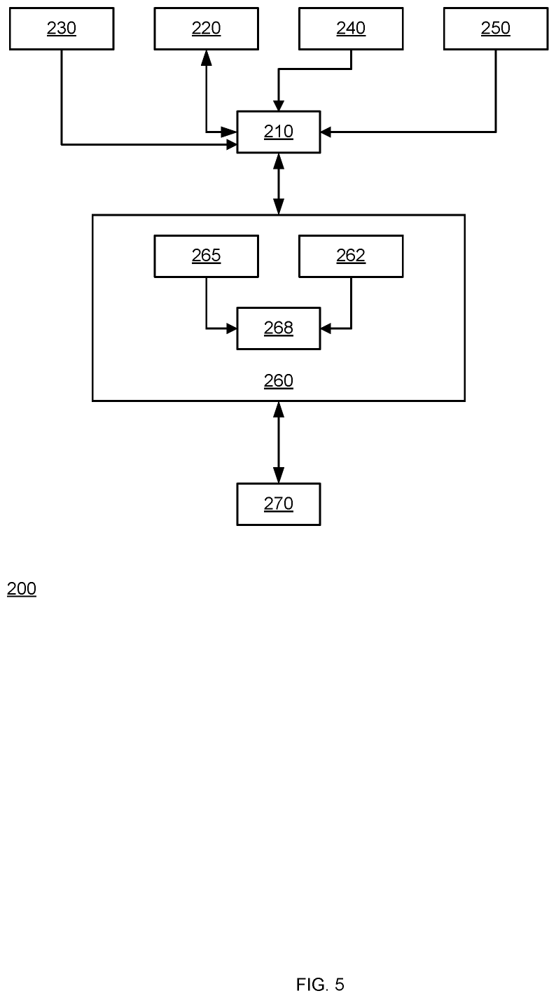

Reference is now made to FIG. 5 which is a block diagram of an exemplary autonomous driving system 200 (hereinafter also referred to as system 200), constructed and implemented in accordance with embodiments described herein.

Autonomous driving system 200 comprises processing circuitry 210, input/output (I/O) module 220, camera 230, telemetry ECU 240, shock sensor 250, autonomous driving manager 260, and database 270.

Autonomous driving manager 260 may be instantiated in a suitable memory for storing software such as, for example, an optical storage medium, a magnetic storage medium, an electronic storage medium, and/or a combination thereof. It will be appreciated that autonomous driving system 200 may be implemented as an integrated component of an onboard computer system in a vehicle, such as, for example, vehicle 100 from FIG. 4. Alternatively, system 200 may be implemented and a separate component in communication with the onboard computer system. It will also be appreciated that in the interests of clarity, while autonomous driving system 200 may comprise additional components and/or functionality e.g., for autonomous driving of vehicle 100, such additional components and/or functionality are not depicted in FIG. 2 and/or described herein.

Processing circuitry 210 may be operative to execute instructions stored in memory (not shown). For example, processing circuitry 210 may be operative to execute autonomous driving manager 260. It will be appreciated that processing circuitry 210 may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits. It will similarly be appreciated that autonomous driving system 200 may comprise more than one instance of processing circuitry 210. For example, one such instance of processing circuitry 210 may be a special purpose processor operative to execute autonomous driving manager 260 to perform some, or all, of the functionality of autonomous driving system 200 as described herein.

I/O module 220 may be any suitable communications component such as a network interface card, universal serial bus (USB) port, disk reader, modem or transceiver that may be operative to use protocols such as are known in the art to communicate either directly, or indirectly, with other elements of system 10 (FIG. 1) and/or system 200, such as, for example, server 400 (FIG. 4), camera 230, telemetry ECU 240, and/or shock sensor 250. As such, I/O module 220 may be operative to use a wired or wireless connection to connect to server 400 via a communications network such as a local area network, a backbone network and/or the Internet, etc. I/O module 220 may also be operative to use a wired or wireless connection to connect to other components of system 200, e.g., camera 230, telemetry ECU 240, and/or shock sensor 250. It will be appreciated that in operation I/O module 220 may be implemented as a multiplicity of modules, where different modules may be operative to use different communication technologies. For example, a module providing mobile network connectivity may be used to connect to server 400, whereas a local area wired connection may be used to connect to camera 230, telemetry ECU 240, and/or shock sensor 250.

In accordance with embodiments described herein, camera 230, telemetry ECU 240, and shock sensor 250 represent implementations of sensor(s) 130 from FIG. 4. It will be appreciated that camera 230, telemetry ECU 240, and/or shock sensor 250 may be implemented as integrated components of vehicle 100 (FIG. 4) and may provide other functionality that is the interests of clarity is not explicitly described herein. As described hereinbelow, system 200 may use information about a current driving environment as received from camera 230, telemetry ECU 240, and/or shock sensor 250 to determine an appropriate driving policy for vehicle 100.

Autonomous driving manager 260 may be an application implemented in hardware, firmware, or software that may be executed by processing circuitry 210 to provide driving instructions to vehicle 100. For example, autonomous driving manager 260 may use images received from camera 230 and/or telemetry data received from telemetry ECU 240 to determine an appropriate driving policy for arriving at a given destination and provide driving instructions to vehicle 100 accordingly. It will be appreciated that autonomous driving manager 260 may also be operative to use other data sources when determining a driving policy, e.g., maps of potential routes, traffic congestion reports, etc.

As depicted in FIG. 5, autonomous driving manager 260 comprises event detector 265, event predictor 262, and autonomous driving pattern module 268. It will be appreciated that the depiction of event detector 265, event predictor 262, and autonomous driving pattern module 268 as integrated components of autonomous driving manager 260 may be exemplary. The embodiments described herein may also support implementation of event detector 265, event predictor 262, and autonomous driving pattern module 268 as independent applications in communication with autonomous driving manager 260, e.g., via I/O module 220.

Event detector 265, event predictor 262, and autonomous driving pattern module 268 may be implemented in hardware, firmware, or software and may be invoked by autonomous driving manager 260 as necessary to provide input to the determination of an appropriate driving policy for vehicle 100. For example, event detector 265 may be operative to use information from sensor(s) 130 (FIG. 4), e.g., camera 230, telemetry ECU 240, and/or shock sensor 250 to detect event s in (or near) the driving path of vehicle 100, e.g., along (or near) roadway 20 (FIG. 4). Event predictor 262 may be operative to use event information received from autonomous driving pattern server 400 to predict the location of event s along or near roadway 20 before, or in parallel to their detection by event detector 265. Autonomous driving pattern module 268 may be operative to determine an appropriate driving pattern based at least on events detected/predicted (or not detected/predicted) by event detector 265 and/or event predictor 262.

Autonomous driving manager 260 may store event type identifiers received from server 400 in database 270 for use by event detector 265, event predictor 262, and autonomous driving pattern module 268 as described herein. It will be appreciated that driving patterns to be applied when encountering events of different types may also be stored in database 270 for use by event detector 265, event predictor 262, and autonomous driving pattern module 268.

Depending on the configuration of system 100, the information from server 400 may be received in a batch update process, either periodically and/or triggered by an event, e.g., when vehicle 100 is turned on, when vehicle 100 enters a new map area, when vehicle 100 enters an area with good wireless reception, etc.

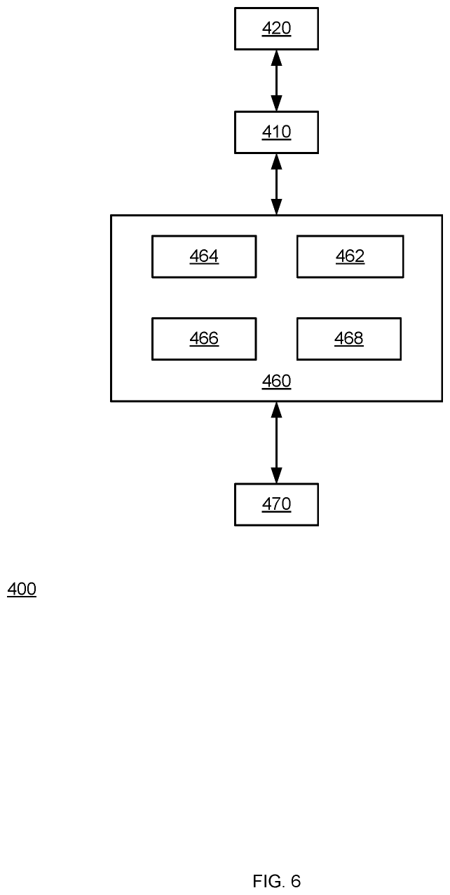

Reference is now made to FIG. 6 which is a block diagram of a server 400 (hereinafter also referred to as server 400), constructed and implemented in accordance with embodiments described herein.

Server 400 comprises processing circuitry 410, input/output (I/O) module 420, autonomous driving pattern manager 460, and database 470. Autonomous driving pattern manager 460 may be instantiated in a suitable memory for storing software such as, for example, an optical storage medium, a magnetic storage medium, an electronic storage medium, and/or a combination thereof.

Processing circuitry 410 may be operative to execute instructions stored in memory (not shown). For example, processing circuitry 410 may be operative to execute autonomous driving pattern manager 260. It will be appreciated that processing circuitry 410 may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits. It will similarly be appreciated that server 400 may comprise more than one instance of processing circuitry 410. For example, one such instance of processing circuitry 410 may be a special purpose processor operative to execute autonomous driving pattern manager 460 to perform some, or all, of the functionality of server 400 as described herein.

I/O module 420 may be any suitable communications component such as a network interface card, universal serial bus (USB) port, disk reader, modem or transceiver that may be operative to use protocols such as are known in the art to communicate either directly, or indirectly, with other elements of system 10 (FIG. 4) such as, for example, system 200 (FIG. 5). As such, I/O module 420 may be operative to use a wired or wireless connection to connect to system 200 via a communications network such as a local area network, a backbone network and/or the Internet, etc. It will be appreciated that in operation I/O module 220 may be implemented as a multiplicity of modules, where different modules may be operative to use different communication technologies. For example, a module providing mobile network connectivity may be used to connect wirelessly to one instance of system 200, e.g., one vehicle 100 (FIG. 4), whereas a local area wired connection may be used to connect to a different instance of system 100, e.g., a different vehicle 100.

Autonomous driving pattern manager 460 may be an application implemented in hardware, firmware, or software that may be executed by processing circuitry 410 to provide event type identifiers and tailored tailored autonomous driving pattern information for each one of the multiple types of events.

As depicted in FIG. 4, autonomous driving pattern manager 460 may include event detector 462, event type detector 464, event type human driving pattern processor manager 466, and tailored autonomous driving pattern generator 468. It will be appreciated that the depiction of event detector 462, event type detector 464, event type human driving pattern processor manager 466, and tailored autonomous driving pattern generator 468 as integrated components of autonomous driving pattern manager 460 may be exemplary. The embodiments described herein may also support implementation of event detector 462, event type detector 464, event type human driving pattern processor manager 466, and tailored autonomous driving pattern generator 468 as independent applications in communication with autonomous driving pattern manager 460, e.g., via I/O module 420.

Event detector 462, event type detector 464, event type human driving pattern processor manager 466, and tailored autonomous driving pattern generator 468 may be implemented in hardware, firmware, or software and may be invoked by autonomous driving pattern manager 460 as necessary to provide obstacle warnings and associated driving policies to vehicles 100. For example,

Event detector 462 may perform step 2020, event type detector 464 may perform step 2030, event type human driving pattern processor manager 466 may execute step 2042, and tailored autonomous driving pattern generator 468 may execute step 2044.

Autonomous driving pattern manager 460 may store obstacle information received from a vehicle in database 270 for use by event detector 462, event type detector 464, event type human driving pattern processor manager 466, and tailored autonomous driving pattern generator 468.

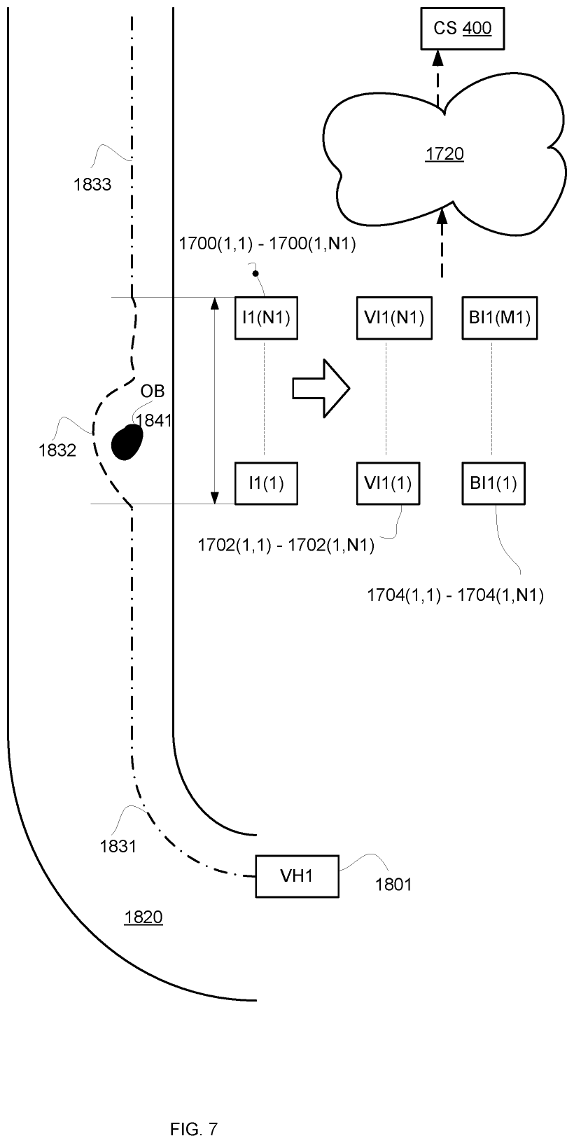

Each one of FIGS. 7-21 may illustrate a learning process and/or an applying process.

During the learning process the vehicle may encounter events, driving information and environmental sensor information indicative of information sensed by the vehicle generated by the vehicle and sent to the—that may apply method 2000.

During an applying process the vehicle may benefit from the products of the learning process- and may execute method 2100 and/or 2102.

Thus each one of FIGS. 7-21 may illustrate different events of different event types that once detected by the vehicle—the vehicle may apply tailored autonomous driving patterns.

For simplicity of explanation the following text may refer to one of these processes.

FIG. 7 illustrates a first vehicle (VH1) 1801 that propagates along a road 1820. First vehicle 1801 performs a maneuver 1832 suspected as being an obstacle avoidance maneuver when encountered with obstacle 1841. Maneuver 1832 is preceded by a non-suspected maneuver 1831 and is followed by another non-suspected maneuver 1833.

First vehicle 1801 acquires a first plurality (N1) of images I1(1)-I1(N1) 1700(1,1)-1700(1,N1) during obstacle avoidance maneuver 1832.

Environmental sensor information such as visual information V1(1)-V1(N1) 1702(1,1)-1702(1,N1) is sent from first vehicle 1801 to computerized system (CS) 400 via network 1720.

The visual information may be the images themselves. Additionally or alternatively, first vehicle processes the images to provide a representation of the images.

First vehicle 1801 may also transmit driving information such as behavioral information B1(1)-B1(N1) 1704(1,1)-1704(1,N1) that represents the behavior of the vehicle during maneuver 1832.

Alternatively, during an applying process, the vehicle may detect an event type that includes the obstacle and may apply the relevant tailored autonomous driving pattern.

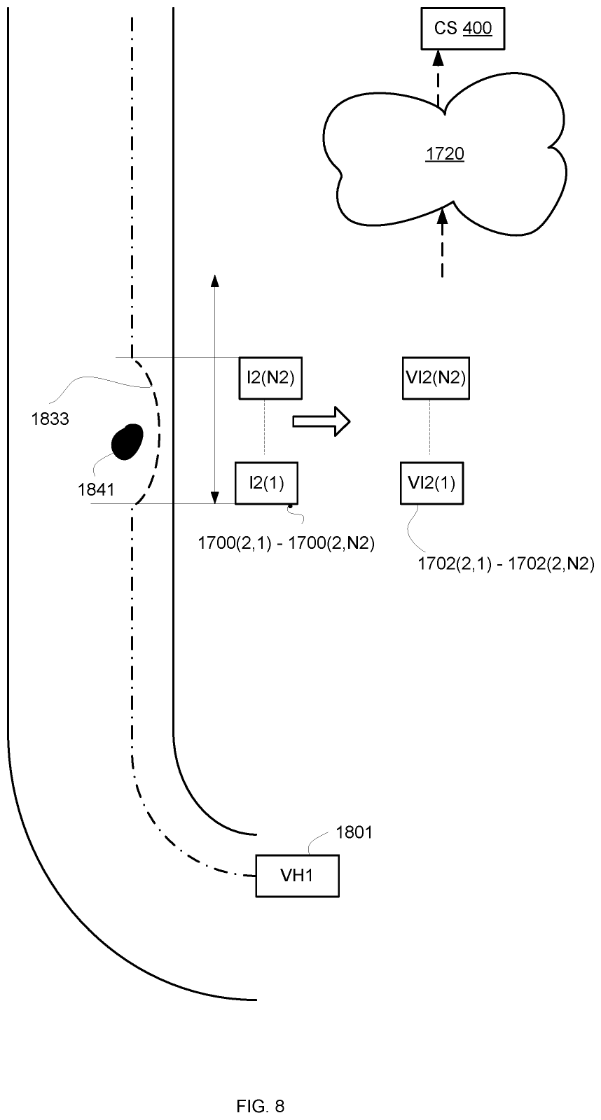

FIG. 8 illustrates VH1 1801 that propagates along a road 1820. VH1 1801 performs a maneuver 1833 suspected as being an obstacle avoidance maneuver when encountered with obstacle 1841. Maneuver 1833 is preceded by a non-suspected maneuver and is followed by another non-suspected maneuver.

VH1 1801 acquires a second plurality (N2) of images I2(1)-I2(N2) 1700(2,1)-1700(2,N2) during maneuver 1833.

Environmental sensor information such as visual information V2(1)-V2(N2) 1702(2,1)-1702(2,N2) is sent from VH1 1801 to computerized system (CS) 400 via network 1720.

The visual information may be the images themselves. Additionally or alternatively, second vehicle processes the images to provide a representation of the images.

VH1 may also transmit driving information such as behavioral information (not shown) that represents the behavior of the vehicle during maneuver 1832.

Alternatively, during an applying process, the vehicle may detect an event type that includes the obstacle and may apply the relevant tailored autonomous driving pattern.

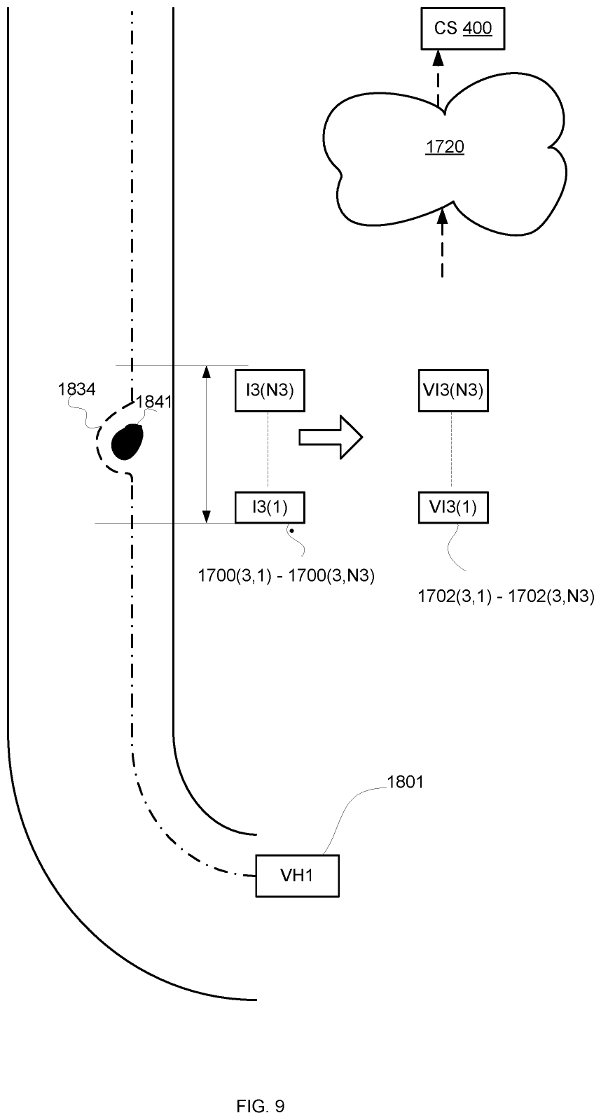

FIG. 9 illustrates VH1 1801 that propagates along a road. Third vehicle 1803 performs a maneuver 1834 suspected as being an obstacle avoidance maneuver when encountered with obstacle 1841. Maneuver 1834 is preceded by a non-suspected maneuver and is followed by another non-suspected maneuver.

VH1 acquires a third plurality (N3) of images I3(1)-I3(N3) 1700(3,1)-1700(3,N3) during maneuver 1834.

Environmental sensor information such as visual information V3(1)-V3(N3) 1702(3,1)-1702(3,N3) is sent from VH1 1801 to computerized system (CS) 400 via network 1720.

The visual information may be the images themselves. Additionally or alternatively, third vehicle processes the images to provide a representation of the images.

VH1 may also transmit driving information such as behavioral information (not shown) that represents the behavior of the vehicle during maneuver 1832.

Alternatively, during an applying process, the vehicle may detect an event type that includes the obstacle and may apply the relevant tailored autonomous driving pattern.

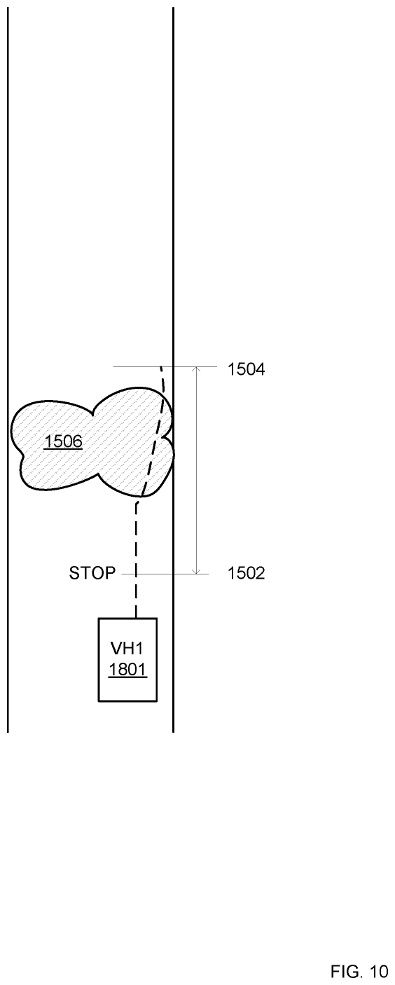

FIG. 10 illustrates first vehicle VH1 1801 as stopping (position 1502) in front of a puddle 1506 and then passing the puddle (may drive straight or change its direction till ending the maneuver at point 1504. The vehicle can generate and send driving information and environmental sensor information related to the puddle.

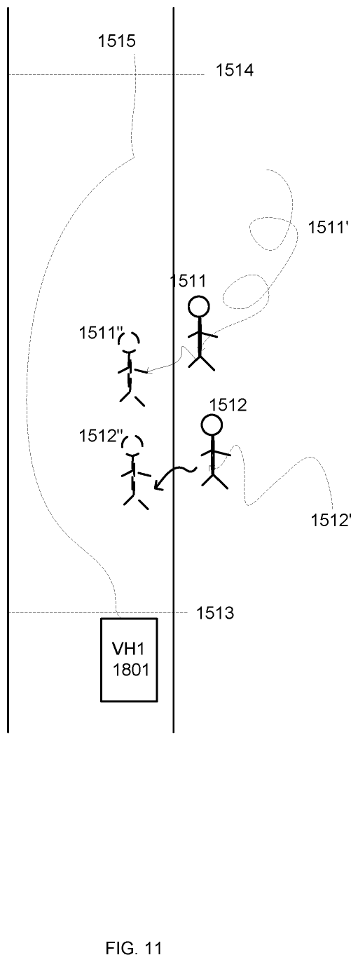

FIG. 11 illustrates first vehicle VH1 1801 as sensing pedestrians 1511 and 1512. The vehicle may sense the movements of the pedestrians—which may be regarded as sensor environmental information.

Environmental sensor information such as visual information acquired between positions 1513 and 1514 (end of the maneuver) may be sent to the server.

Alternatively, during an applying process, the vehicle may detect an event type that includes the pedestrians (and even their speed or any other parameter related to their walking pattern) parking vehicles and may apply the relevant tailored autonomous driving pattern.

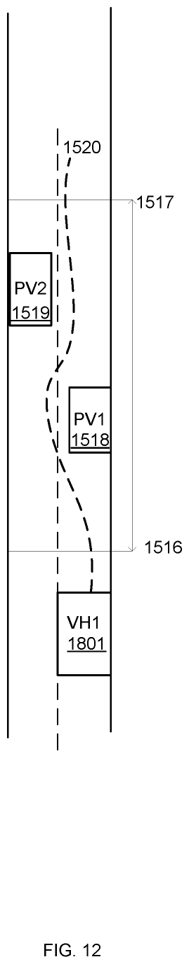

FIG. 12 illustrates first vehicle VH1 1801 as sensing parked vehicles PV1 1518 and PV2 1519 that part on both sides of a double-lane bi-directional road, that require the first vehicle to perform a complex maneuver 1520 that includes changing lanes and changing direction relatively rapidly.

Driving information and environmental sensor information related to the driving between the vehicles may be obtained and sent to the remote computer that generates a tailored autonomous driving pattern.

Alternatively, during an applying process, the vehicle may detect an event type that includes the parking vehicles and may apply the relevant tailored autonomous driving pattern.

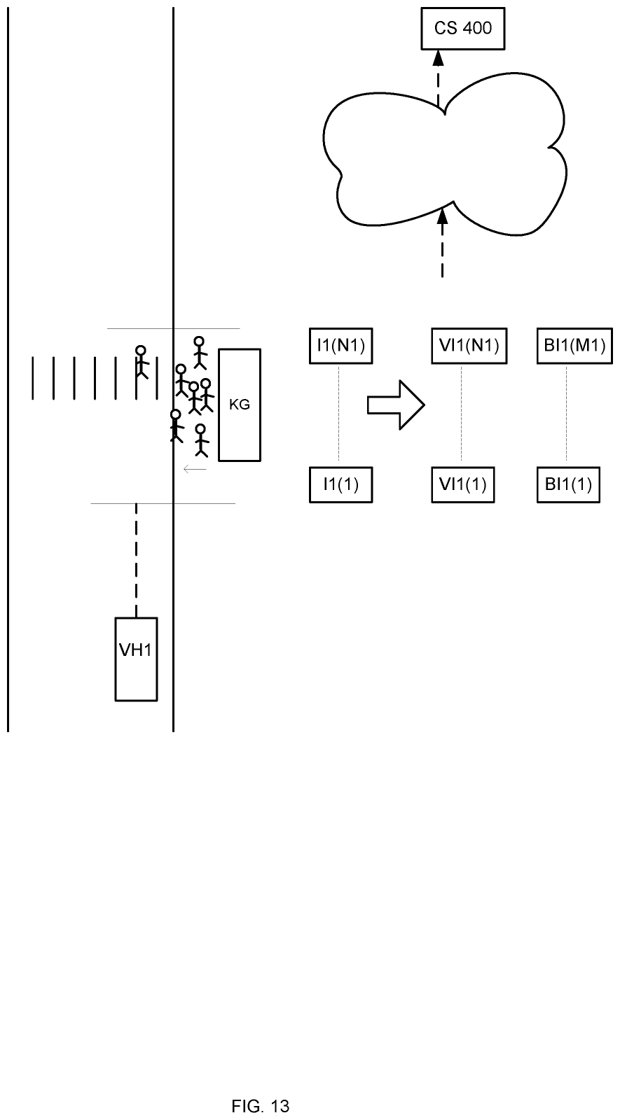

FIG. 13 illustrates a vehicle that approaches a zebra crossing located near a kindergarten and pedestrians that pass the zebra crossing.

Driving information and environmental sensor information related to the zebra crossings near the kindergarten and the pedestrians may be obtained and sent to the remote computer that generates a tailored autonomous driving pattern.

Alternatively, during an applying process, the vehicle may detect an event type that includes the zebra crossings near the kindergarten and the pedestrians and may apply the relevant tailored autonomous driving pattern.

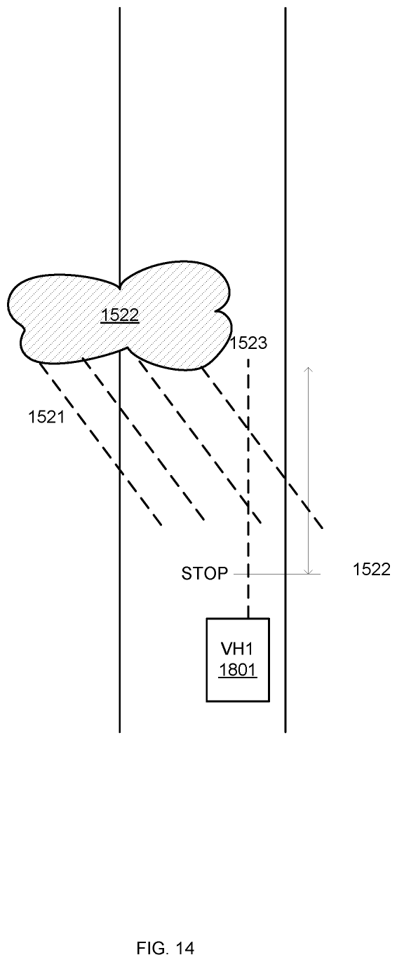

FIG. 14 illustrates first vehicle VH1 1801 as stopping (position 1522) in front of wet segment of the road on which rain 1521 (from cloud 1522) falls. The stop (at location 1522) and any further movement after moving to another part of the road may be regarded as a maneuver 1523 that is indicative that passing the wet segment may require human intervention.

Visual information acquired between position 1522 (beginning of the maneuver) and the end of the maneuver are processed during step 1494.

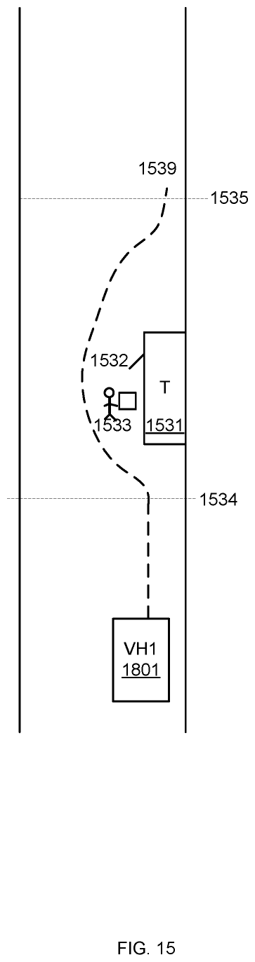

FIG. 15 illustrates first vehicle VH1 1801 as stopping (position 1534) in front of a situation that may be labeled as a packing or unpacking situation—a track 1531 is parked on the road, there is an open door 1532, and a pedestrian 1533 carries luggage on the road. The first vehicle 1801 bypasses the truck and the pedestrian between locations 1534 and 1535 during maneuver 1539. The maneuver may be indicative that a packing or unpacking situation may require human intervention.

Driving information and environmental sensor information related to packing or unpacking situation may be obtained and sent to the remote computer that generates a tailored autonomous driving pattern.

Alternatively, during an applying process, the vehicle may detect an event type that includes packing or unpacking situation and may apply the relevant tailored autonomous driving pattern.

Visual information acquired between positions 1534 and 1535 are processed during step 1494.

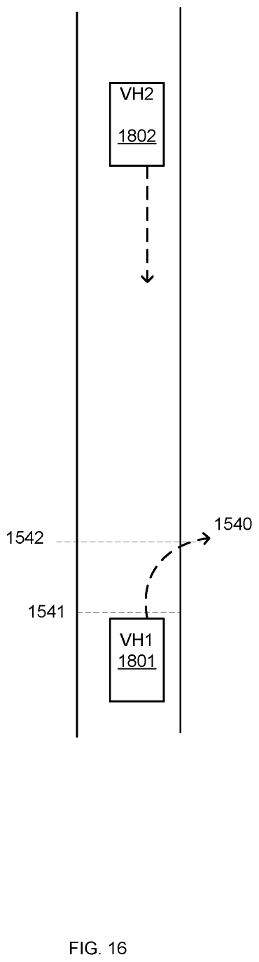

FIG. 16 illustrates first vehicle VH1 1801 as turning away (maneuver 1540) from the road when sensing that it faces a second vehicle VH2 1802 that moves towards VH1 1801.

Driving information and environmental sensor information related to the potential face to face collision may be obtained and sent to the remote computer that generates a tailored autonomous driving pattern.

Alternatively, during an applying process, the vehicle may detect an event type that includes the potential face to face collision and may apply the relevant tailored autonomous driving pattern.

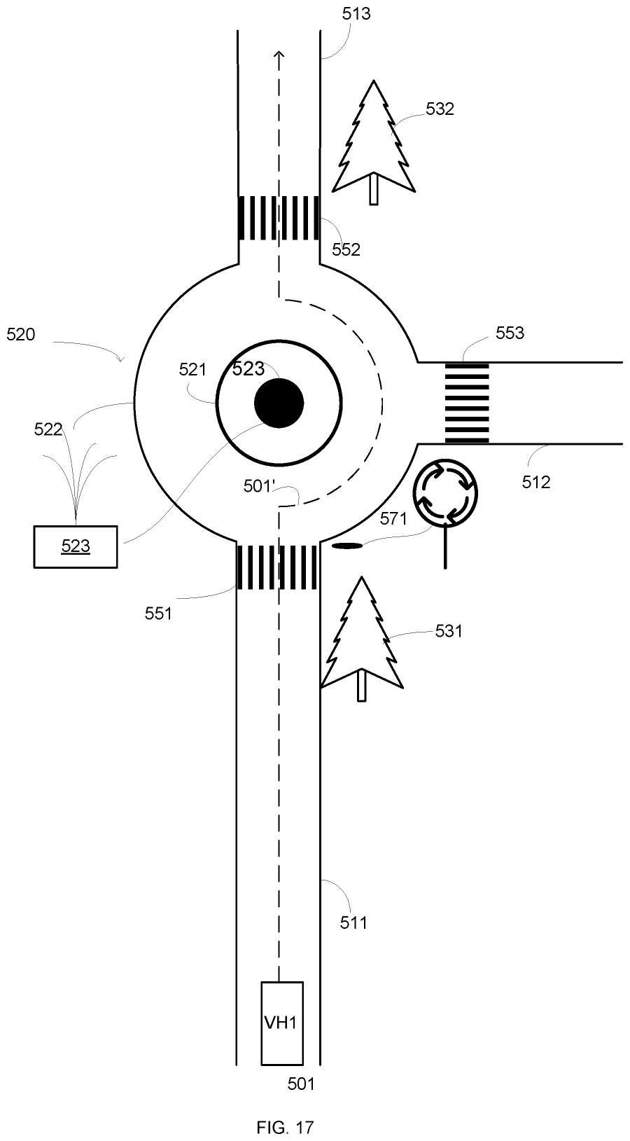

FIG. 17 illustrates first vehicle VH1 1801 as driving through a roundabout 520 that has three arms 511, 512 and 512. VH1 1801 approaches the roundabout (from arm 511), drives within the roundabout and finally exits the roundabout and drives in arm 513. The driving pattern is denoted 501′.

The roundabout 520 is preceded by a roundabout related traffic sign 571, by first tree 531 and by first zebra crossing 551. Arm 512 includes a second zebra crossing 553. Third arm includes third zebra crossing 552. A fountain 523 is positioned in the inner circle 521 of the roundabout. The roundabout has an external border 522. The roundabout is preceded by second tree 532.

Driving information and environmental sensor information related to the potential roundabout may be obtained and sent to the remote computer that generates a tailored autonomous driving pattern.

Alternatively, during an applying process, the vehicle may detect an event type that includes the potential roundabout and may apply the relevant tailored autonomous driving pattern.

The roundabout (or more exactly driving through a roundabout or approaching a roundabout) may be regarded as an event type. Alternatively an event type may be defined per the roundabout and one or more other features related to the roundabout—such as the number of arms, the relative position of the arms, the size of the roundabout, the number of cross roads, the size of the inner circle, the fountain in the center of the roundabout, and the like.

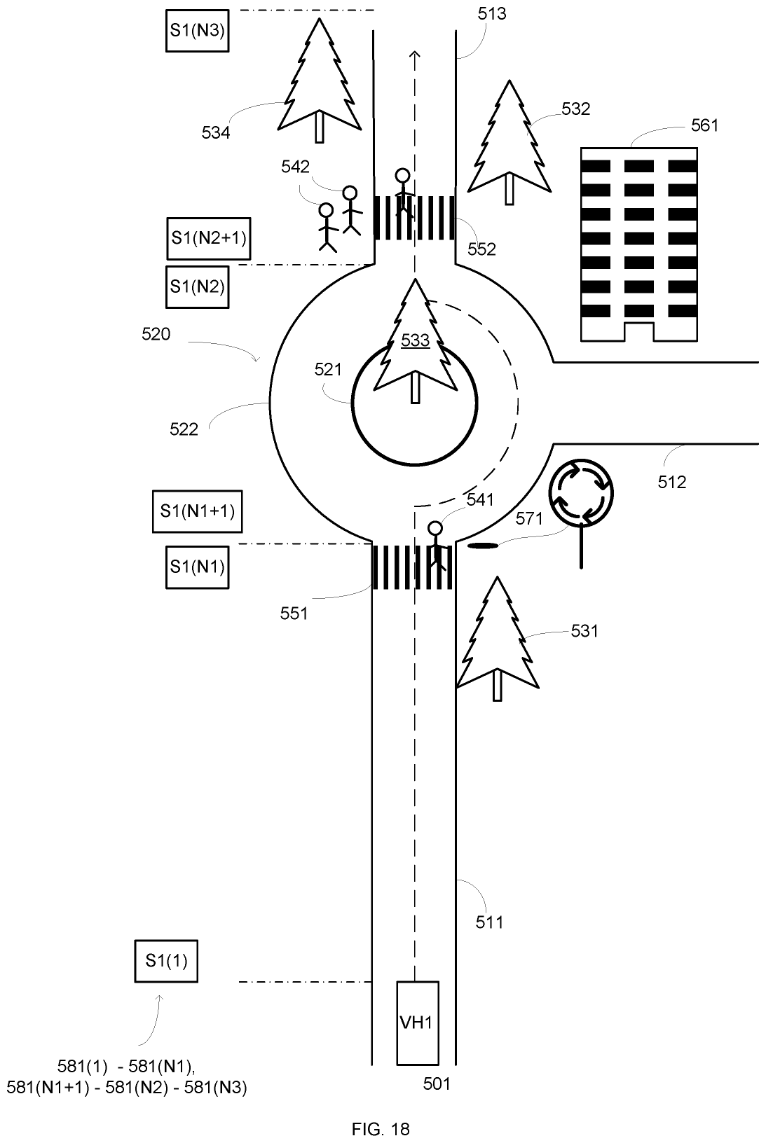

FIG. 18 illustrates first vehicle VH1 1801 as driving through a roundabout 520 that has three arms 511, 512 and 512. VH1 1801 approaches the roundabout (from arm 511), drives within the roundabout and finally exits the roundabout and drives in arm 513. The driving pattern is denoted 501′. FIG. 18 also illustrates pedestrians 541 and 542 that cross first and third zebra crossings 551 and 552 respectively.

FIGS. 18 and 17 may describe an event of the same type—but these figures may represent different event types—due to the presence of pedestrians in FIG. 18.

FIG. 18 also illustrates environmental sensor information generated by the vehicle—581(1)-581(N1), 581(N1+1)-581(N2)-581(N3).

In any of the methods any of the autonomous driving pattern related to the the event type may be amended based on feedback provided by users of the vehicle

It is appreciated that software components of the embodiments of the disclosure may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the disclosure.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable subcombination.

It will be appreciated by persons skilled in the art that the embodiments of the disclosure are not limited by what has been particularly shown and described hereinabove. Rather the scope of the embodiments of the disclosure is defined by the appended claims and equivalents thereof.

What is claimed is:

1. A method for autonomous driving, the method comprises:
receiving, from a vehicle, and by an I/O module of a computerized system, (a) driving information indicative of a manner in which a driver controls the vehicle while driving over a path, and (b) environmental sensor information indicative of information sensed by the vehicle, the environmental sensor information is indicative of the path and the vicinity of the path;
detecting, based on at least the environmental information, multiple events encountered during the driving over the path;
determining event types, wherein each of the multiple events belongs to a certain event type;
for each event type, determining, based on driving information associated with events of the multiple events that belong to the event type, a tailored autonomous driving pattern information that is indicative of a tailored autonomous driving pattern to be applied by the vehicle during an occurrence of the event type;
for each event type, determining, based on environmental sensor information associated with events of the multiple events that belong to the event type, an event type identifier; and
storing in at least one data structure (a) event type identifier for each one of the multiple types of events, and (b) tailored autonomous driving pattern information for each one of the multiple types of events.

2. The method according to claim 1 comprising instructing the vehicle to apply, for each event type, a tailored autonomous driving pattern of the event type.

3. The method according to claim 1 comprising requesting the vehicle to apply, for each event type, a tailored autonomous driving pattern of the event type.

4. The method according to claim 1 wherein the determining, for each event type, the tailored autonomous driving pattern information, is also based on at least one other autonomous driving rule related to a driving of the vehicle during an autonomous driving mode.

5. The method according to claim 4 the at least one other autonomous driving rule comprises a safety rule.

6. The method according to claim 4 the at least one other autonomous driving rule comprises a power consumption rule.

7. The method according to claim 4 the at least one other autonomous driving rule is determined based on an interaction with a user of the vehicle.

8. The method according to claim 1 wherein an aggregate size of the driving information and the environmental sensor information exceeds as aggregate size of the (a) event type identifier for each one of the multiple types of events, and (b) the tailored autonomous driving pattern information for each one of the multiple event types.

9. The method according to claim 1 wherein the determining of the event types is based on at least two parameters out of (a) a location of the event, (b) at least one feature of one or more objects that appear in a vicinity of the vehicle during the event.

10. The method according to claim 9, wherein the at least one feature of one or more objects comprises a type of the one or more objects.

11. The method according to claim 9, wherein the at least one feature of one or more objects comprises a behavior of the one or more objects.

12. The method according to claim 9, wherein the at least one feature of one or more objects comprises a spatial relationship between the vehicle and the one or more objects.

13. The method according to claim 1 wherein the determining of the event types, is executed in an unsupervised manner.

14. The method according to claim 1 wherein the determining of the event types, is based on object recognition.

15. The method according to claim 1 wherein at least one event type identifier is a visual event type identifier for visually identifying an event type.

16. The method according to claim 1 wherein at least one event type identifier is a robust signature of the event type.

17. The method according to claim 1 wherein at least one event type identifier comprises configuration information of a neural network of the vehicle.

18. The method according to claim 1 wherein at least one event type identifier comprises information for sensing an expected future occurrence of an event of the event type.

19. A method for driving a vehicle, the method comprises:
receiving, by the vehicle, multiple event type identifiers related to multiple types of events that occurred during a driving of the vehicle over a path, and (b) tailored autonomous driving pattern information for each one of the multiple types of events; wherein a tailored autonomous driving pattern information of an event type is indicative of a tailored autonomous driving pattern associated to the event type;
sensing, by the vehicle and while driving on a current path, currently sensed information that is indicative of a vicinity of the vehicle and is indicative of a current path;
searching, based on the currently sensed information, for a event type identifier out of the multiple event type identifiers;
when detecting an event type then applying an autonomous driving pattern that is associated to the event type.

20. A method for driving a vehicle, the method comprises:
receiving, by the vehicle, multiple event type identifiers related to multiple types of events that occurred during a driving of the vehicle over a path, and (b) tailored autonomous driving pattern information for each one of the multiple types of events; wherein a tailored autonomous driving pattern information of an event type is indicative of a tailored autonomous driving pattern associated with the event type;
sensing, by the vehicle and while driving on a current path, currently sensed information that is indicative of a vicinity of the vehicle and information about a current path;
searching, based on the currently sensed information, for an event type identifier out of the multiple event type identifiers;
when detecting an event type then determining whether to apply a tailored autonomous driving pattern that is associated with the event type; and
selectively applying, based on the determining, the tailored autonomous driving pattern that is associated with the event type.

21. A non-transitory computer readable medium that stores instructions for:
receiving, from a vehicle, and by an I/O module of a computerized system, (a) driving information indicative of a manner in which a driver controls the vehicle while driving over a path, and (b) environmental sensor information indicative of information sensed by the vehicle, the environmental sensor information is indicative of the path and the vicinity of the path;
detecting, based on at least the environmental information, multiple events encountered during the driving over the path;
determining event types, wherein each of the multiple events belongs to a certain event type;
for each event type, determining, based on driving information associated with events of the multiple events that belong to the event type, a tailored autonomous driving pattern information that is indicative of a tailored autonomous driving pattern to be applied by the vehicle during an occurrence of the event type;
for each event type, determining, based on environmental sensor information associated with events of the multiple events that belong to the event type, an event type identifier; and
storing in at least one data structure (a) event type identifier for each one of the multiple types of events, and (b) tailored autonomous driving pattern information for each one of the multiple types of events

22. A non-transitory computer readable medium that stores instructions for:
receiving, by the vehicle, multiple event type identifiers related to multiple types of events that occurred during a driving of the vehicle over a path, and (b) tailored autonomous driving pattern information for each one of the multiple types of events; wherein a tailored autonomous driving pattern information of an event type is indicative of a tailored autonomous driving pattern associated with the event type;
sensing, by the vehicle and while driving on a current path, currently sensed information that is indicative of a vicinity of the vehicle and information about a current path;
searching, based on the currently sensed information, for an event type identifier out of the multiple event type identifiers;
when detecting an event type then determining whether to apply a tailored autonomous driving pattern that is associated with the event type; and
selectively applying, based on the determining, the tailored autonomous driving pattern that is associated with the event type.
